(19) United States
(12) Patent Application Publication
(10) Pub. No.: US 2016/0189726 A1
(43) Pub. Date: Jun. 30, 2016

(54) MECHANISM FOR FACILITATING DYNAMIC ADJUSTMENT OF AUDIO INPUT/OUTPUT (I/O) SETTING DEVICES AT CONFERENCING COMPUTING DEVICES

(71) Applicant: INTEL CORPORATION, Santa Clara, CA (US)

(72) Inventors: Sundeep RANIWALA, Sacramento, CA (US); STANLEY JACOB BARAN, Elk Grove, CA (US); MICHAEL P. SMITH, Folsom, CA (US); VINCENT A. FLETCHER, Cameron Park, CA (US); CYNTHIA KAY PICKERING, Pheonix, AZ (US); NATHAN HORN, Fair Oaks, CA (US)

(21) Appl. No.: 13/977,693

(22) PCT Filed: Mar. 15, 2013
(86) PCT No.: PCT/US2013/032649

§ 371 Date: Jun. 29, 2013

(51) Int. Cl. G10L 21/0208; G06F 3/16; G10L 25/84

(52) U.S. Cl. CPC G10L 21/0208; G10L 25/84; G06F 3/165; G10L 2021/02082

(57) ABSTRACT

A mechanism is described for facilitating dynamic adjustment of audio input/output setting devices at conferencing computing devices according to one embodiment. A method of embodiments, as described herein, includes maintaining awareness of proximity between a plurality of computing devices participating in a conference, detecting audio disturbance relating to the plurality of computing devices, and calculating adjustments to settings of one or more audio input/output (I/O) devices coupled to one or more of the plurality of computing devices to eliminate the audio disturbance. The adjustments may be dynamically applied to the settings of the one or more audio I/O devices.

### FIELD

Embodiments described herein generally relate to computer programming. More particularly, embodiments relate to a mechanism for facilitating dynamic adjustment of audio input/output setting devices at conferencing computing devices.

### BACKGROUND

Conferencing using computing devices is commonplace today. However, several audio-related problems are encountered with multiple computing devices are used to participate in conferencing in a room. Some of the problems are encountered with dealing with speaker noise, feedback, and echo; for example, conventional systems do not provide any solution to prevent feedback (which is common occurrence with several participating devices are in close proximity). Similarly, conventional systems are not equipped to handle presenter (here presenter refers to anyone speaking in the room echoes or even audio feedback when a human speaker speaks through a participating device that is in close proximity to other participating devices.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a dynamic audio input/output adjustment mechanism for facilitating dynamic adjustment of audio input/output setting devices at conferencing computing devices according to one embodiment.

FIG. 2 illustrates adjustment mechanism according to one embodiment.

FIG. 3 illustrates a method for facilitating dynamic adjustment of audio input/output setting devices at conferencing computing devices according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments facilitate dynamic and automatic adjustment of input/output (I/O) setting devices (e.g., microphone, speaker, etc.) to prevent certain noise-related problems typically associated with conferring computing devices within a close proximity and/or in a small area (e.g., a conference room, an office, etc.). In one embodiment, as will be subsequently described in this document, any feedback noise or echo may be avoided or significantly reduced by having a mechanism dynamically and automatically adjust settings on microphones and/or speaker of the participating devices. Similarly, for example, when a human participant speaks up in small area with multiple participating devices, the mechanism may selectively, automatically and dynamically change the settings (e.g., turn lower or higher or turn off or on) one or more speakers and/or microphones of one or more participating devices (depending on their proximity from the speaker) so that the speaker may be listened to directly by other human participants without the need for audio feeds or repetitions from the participating device speakers which can cause noise problems, such as echo, feedback, and other disturbances.

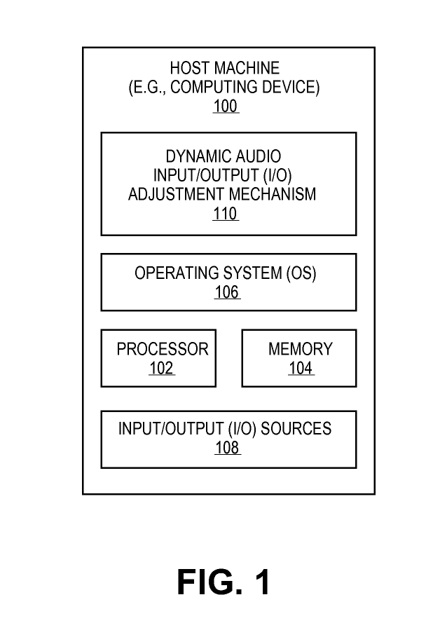

FIG. 1 illustrates a dynamic audio input/output adjustment mechanism 110 for facilitating dynamic adjustment of audio input/output setting devices at conferencing computing devices according to one embodiment. Computing device 100 serves as a host machine to employ dynamic audio input/output (I/O) adjustment mechanism (“adjustment mechanism”) 110 for facilitating dynamic adjustment of audio I/O setting devices at conferencing computing devices, such as computing device 100.

In one embodiment, adjust mechanism 110 may be hosted by computing device 100 serving as a server computer in communication with any number and type of client or participating conferencing computing devices (“participating devices”) over a network (e.g., cloud-based computing network, Internet, intranet, etc.). For example and in one embodiment, adjust mechanism 110 may locate nearby participating computing device via a software application programming interface (API) that may be used to track nearby participating devices having access to a conferencing software application (which may downloaded on the participating devices or accessed by them over a network, such as a cloud network). Once adjustment mechanism 110 becomes aware of participating devices nearby, the conferencing application on each participating device may be used to intelligently adjust the speaker output volume or the microphone gain of such participating devices that are close enough to each other so that any feedback noise, echo, etc., may be avoided.

Computing device 100 may include mobile computing devices, such as cellular phones including smartphones (e.g., iPhone® by Apple®, BlackBerry® by Research in Motion®, etc.), personal digital assistants (PDAs), etc., tablet computers (e.g., iPad® by Apple®, Galaxy 3® by Samsung®, etc.), laptop computers (e.g., notebook, netbook, Ultrabook™, etc.), e-readers (e.g., Kindle® by Amazon®, Nook® by Barnes and Nobles®, etc.), etc. Computing device 100 may further include set-top boxes (e.g., Internet-based cable television set-top boxes, etc.), and larger computing devices, such as desktop computers, server computers, etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “client”, “host”, “server”, “memory server”, “machine”, “device”, “computing device”, “computer”, “computing system”, and the like, may be used interchangeably throughout this document.

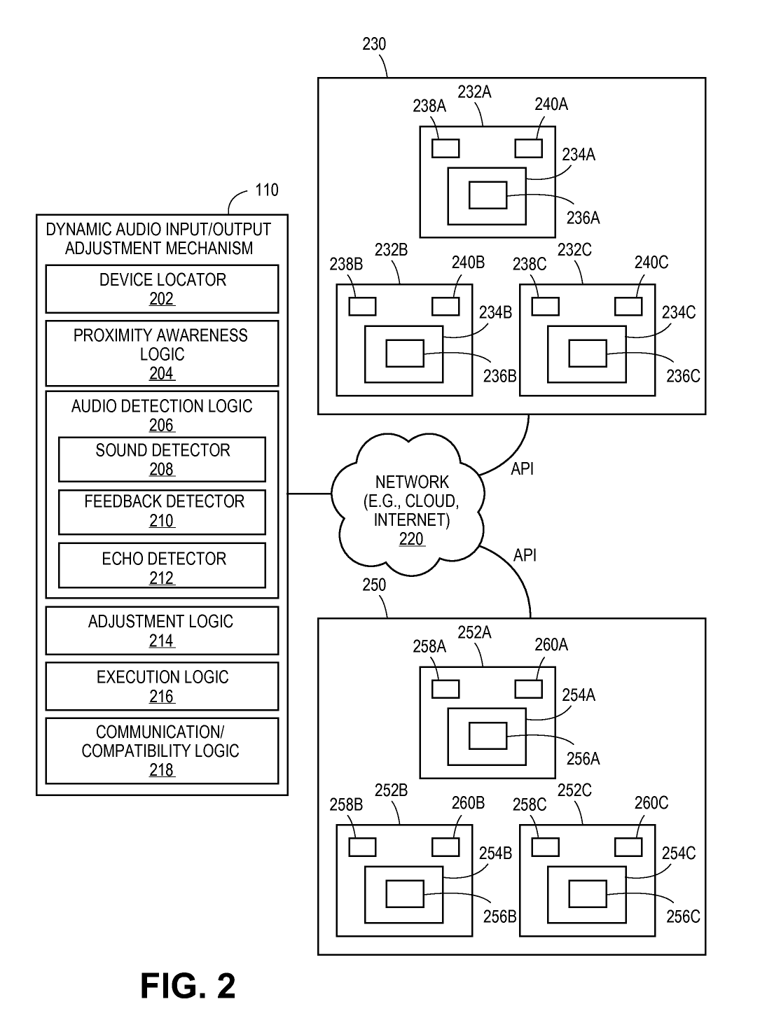

FIG. 2 illustrates adjustment mechanism 110 according to one embodiment. In one embodiment, adjustment mechanism 110 includes a number of components, such as device locator 202, proximity awareness logic 204, audio detection logic 206 including sound detector 208, feedback detector 210 and echo detector 212, adjustment logic 214, execution logic 216, and communication/compatibility logic 218. Throughout this document, “logic” may be interchangeably referred to as “component” or “module” and may include, by way of example, software, hardware, and/or any combination of software and hardware, such as firmware.

In one embodiment, adjustment mechanism 110 facilitates dynamic adjustment of audio I/O settings to avoid or significantly reduce noise-related issues so as to facilitate multi-device conferencing including any number and type of participating devices within close proximity of each other, which also overcomes the conventional limitation of having a single participating device in close area. Adjustment mechanism 110 may be employed at and hosted by a computing device (e.g., computing device 100 of FIG. 1) having a server computer that may include any number and type of server computers, such as a generic server computer, a customized server computer made for a particular organization and/or for facilitating certain tasks, or other known/existing computer servers, such as Lync® by Microsoft®, Aura® by Avaya®, Unified Presence Server® by Cisco®, Lotus Sametime® by IBM®, Skype® server, Viber® server, OpenScape® by Siemens®, etc.

It is contemplated that embodiment not limited in any manner and that, for example, any number and type of components 202-218 of adjustment mechanism 110 as well as any other or third-party features, technologies, and/or software (e.g., Lync, Skype, etc.) are not limited to be provided through or hosted at computing device 100 and that any number and type of them may be provided other or additional levels of software or tiers including, for example, via an application programming interface (“API” or “user interface” or simply “interface”) 236A, 236B, 236C, 256A, 256B, 256C provided through a software application 234A, 234B, 234C, 254A, 254B, 254C at a client computing devices 232A, 232B, 232C, 252A, 252B, 252C. Similarly, it is contemplated that any number and type of audio controls 238A, 238B, 238C, 258A, 258B, 258C, 240A, 240B, 240C, 260A, 260B, 260C may be exposed through interfaces 236A, 236B, 236C, 256A, 256B, 256C to some a higher order application and may be maintained directly on the client platform of client devices 232A, 232B, 232C, 252A, 252B, 252C or elsewhere, as desired or necessitated. It is to be noted that embodiments are illustrated by way of example for brevity, clarity, ease of understanding, and not to obscure adjustment mechanism 110, and not by way of limitation.

In one embodiment, device locator 202 of adjustment mechanism 110 detects various participating computing devices, such as any one or more of participating devices 232A, 232B, 232C, 252A, 252B, 252C, prepared or getting prepared to join a conference. As illustrated, participating devices may be remotely located in various locations (e.g., countries, cities, offices, homes, etc.), such as, participating devices 232A, 232B, 232C are located in conference room A 230 in building A in city A, while participating devices 252A, 252B, 252C are located in another conference room B 250 in building B in city B and all these participating devices 232A, 232B, 232C, 252A, 252B, 252C are shown to be in communication with each other as well as with adjustment mechanism 110 at a server computer over a network, such as network 220 (e.g., cloud-based network, Internet, etc.).

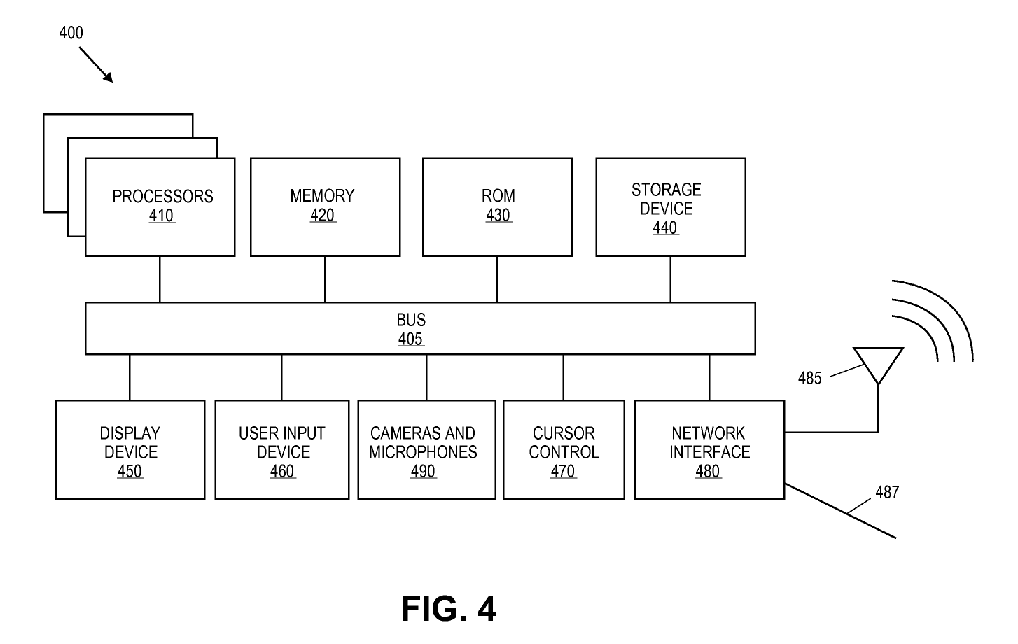

It is contemplated that participating devices 232A, 232B, 232C, 252A, 252B, 252C may be regarded as client computing devices and be similar to or the same as computing devices 100 and 400 of FIGS. 1 and 4, respectively. It is further contemplated that for the sake of brevity, clarity, ease of understanding, and to avoid obscuring adjustment mechanism 110, participating devices 232A, 232B, 232C, 252A, 252B, 252C in conference rooms 230 and 250 are shown merely as an example and that embodiments are not limited to any particular number, type, arrangement, distance, etc., of participating devices 232A, 232B, 232C, 252A, 252B, 252C or their locations 230, 250.

Referring back to device locator 202, location of any one or more of participating devices 232A, 232B, 232C, 252A, 252B, 252C all over the world may be performed using any number and type of available technologies, techniques, methods, and/or networks (e.g., using radio signals over radio towers, Global System for Mobile (GSM) communications, location-based service (LBS), multilateration of radio signals, network-based location detection, SIM-based location detection, Bluetooth, Internet, intranet, cloud-computing, or the like). Further, each participating device 232A, 232B, 232C, 252A, 252B, 252C may include a software application 234A, 234B, 234C, 254A, 254B, 254C (e.g., software programs, such as conferencing applications (e.g., Skype®, etc.), social network websites (e.g., Facebook®, LinkedIn®, etc.), any number and type of websites, etc.) that may be downloaded at participating devices 232A, 232B, 232C, 252A, 252B, 252C and/or accessed through cloud networking, etc. Further, as illustrated, each software application 234A, 234B, 234C, 254A, 254B, 254C provides an application user interface 236A, 236B, 236C, 256A, 256B, 256C that may be accessed and used by the user to participate in audio/video conferencing, changing settings or preferences (e.g. volume, video brightness, etc.), etc.

In one embodiment, user interfaces 236A, 236B, 236C, 256A, 256B, 256C may be used to keep participating devices 232A, 232B, 232C, 252A, 252B, 252C in connection and proximity with each other as well as for providing, receiving, and/or implement any information or data relating to adjustment mechanism 110. For example, once adjustment recommendations have been made, via adjustment logic 214 and execution logic 216, for one or more audio I/O setting devices (e.g., microphones 238A, 238B, 238C, 258A, 258B, 258C, speakers 240A, 240B, 240C, 260A, 260B, 260C), the corresponding user interfaces 236A, 236B, 236C, 256A, 256B, 256C may be used to automatically implement those recommendations and/or, depending on user settings, the recommended changes may be communicated (e.g., displayed) to the users via user interfaces 236A, 236B, 236C, 256A, 256B, 256C so that a user may choose to manually perform any of the recommended changes.

Once the location of each participating device 232A, 232B, 232C, 252A, 252B, 252C is known, this location information is then provided to proximity awareness logic. Using the location information obtained from device locator 202, proximity awareness logic 204 may continue to dynamically maintain the proximity or distance between participating devices 232A, 232B, 232C, 252A, 252B, 252C.

For example, proximity awareness logic 204 may dynamically maintain that the distance between participating devices 232A and 232B is 4 feet, but the distance between participating devices 232A and 252A may be 400 miles. Further, the proximity between participating devices 232A, 232B, 232C, 252A, 252B, 252C may be maintain dynamically by proximity awareness logic 204, such as any change of distance between devices 232A, 232B, 232C, 252A, 252B, 252C may be detected or noted by device locator 202 and forwarded on to proximity awareness logic 204 so that it is kept dynamically aware of the change. For example, if the individual at participating device 232B (e.g., a laptop computer) gets up and takes another seat in the conference could mean an increase and/or decrease of distance between participating device 232B and participating devices 232A (e.g., an increase of distance from 4 feet to 5 feet) and 232C (e.g., a decrease of distance from 4 feet to 2 feet) within room 230.

In one embodiment, audio detection logic 206 includes modules like sound detector 208, feedback detector 210 and echo detector 212 to detect audio changes (e.g., any sounds, noise, feedback, echo, etc.) so that appropriate adjustment to audio settings may be calculated by adjustment logic 214, recommended by execution logic 216, and applied at one or more audio I/O setting devices (e.g., microphones 238A, 238B, 238C, 258A, 258B, 258C, speakers 240A, 240B, 240C, 260A, 260B, 260C) of one or more participating devices 232A, 232B, 232C, 252A, 252B, 252C via one or more user interfaces 236A, 236B, 236C, 256A, 256B, 256C.

For example, the primary speaker of the illustrated example is the person using participating device 232A so all participating devices in each of room 230 and room 250 are maintained accordingly. Now let us suppose, the user at participating device 252A decides to participate and speaks up as a secondary speaker. Given the primary speaker is located in room 230, any microphones 258A, 258B, 258C in room 250 were probably lowered or turned off while speakers 260A, 260B, 260C were probably tuned up so they could clearly listen to the remotely-located primary speaker. However, with the user of device 252A now participating as a secondary speaker, if no adjustment is made, the secondary speaker's participation could cause a rather unpleasant echo by having the secondary speaker's live voice getting duplicated (possibly with a slight delay) with the same voice being emitted from speakers 260A, 260B, 260C. Meanwhile, in room 230, if, for example, speakers 240A, 240B, 240C there were turned off or lowered because of the primary speaker, they may not be able to listen to the secondary speaker from room 250 or might result in some feedback through the primary user's microphone 238A if an appropriate adjustment is not made to speakers 240A, 240B, 240C and/or microphones 238A, 238B, 238C in room 230.

Continuing with the above example, to avoid the aforementioned audio problems, in one embodiment, sound detector 208 in room 250 may first detect a sound as the secondary speaker turns on microphone 258A and begins to talk. It is contemplated that in some embodiments that sound detector 208 or any sound or device detection techniques disclosed herein may include any number of logic and devices, such as, but not limited to, Bluetooth, Near Field Communication (NFC), WiFi or Wi-Fi, etc., in addition to audio-based methods, such as ultrasonic, etc. First, this information may be communicated to adjustment logic 214 so it may calculate, given the proximity of participating devices 252A, 252B, 252C with each other, how much of volume need be adjusted for speakers 260A, 260B, 260C. In some embodiments, speakers 260A, 260B, 260C and their associated microphones 258A, 258B, 258C may be correspondingly and simultaneously adjusted to achieve the best noise adjustment, such as, in this case, to cancel out or minimize the echo or any potential of echo. For example, in one embodiment, upon detection of the secondary speaker by sound detector 208, potential echo and/or feedback may be automatically anticipated and taken into consideration by adjustment logic 214 in recommending any adjustments. In another embodiment, the actual feedback and echo may be detected by feedback detector 210 and echo detector 212, respectively, and such detection information may then be provided to adjustment logic 214 to be considered for calculation purposes for appropriate recommendations for one or more audio I/O devices (e.g., microphones 258A, 258B, 258C, speakers 260A, 260B, 260C) of room 230.

Continuing still with the above example, similar measures may be taken for room 230, such as, in one embodiment, any potential feedback or echo may be anticipated by adjustment logic 214 upon knowing of and the level of sound of the secondary speaker detected by sound detector 208. In another embodiment, the actual feedback may be detected by feedback detector 210 or any actual echo may be detected by echo detector 212 and the findings may then be used by adjustment logic 214 to calculate appropriate adjustment recommendations for one or more audio I/O devices (e.g., microphones 238A, 238B, 238C, speakers 240A, 240B, 240C) of room 250.

In one embodiment, adjustment calculations performed by adjustment logic 214 may then be turned into I/O device setting adjustment recommendations by execution logic 216 so they may be communicated and then dynamically executed, automatically or manually, at one or more audio I/O setting devices (e.g., microphones 238A, 238B, 238C, 258A, 258B, 258C, speakers 240A, 240B, 240C, 260A, 260B, 260C) of one or more participating devices 232A, 232B, 232C, 252A, 252B, 252C via one or more user interfaces 236A, 236B, 236C, 256A, 256B, 256C. This technique is performed to significantly reduce or entirely eliminate any potential and/or actual feedback and/or echo in conferencing rooms 230, 250.

It is contemplated that embodiments are not limited to the above example and that any number and type of other scenarios may be considered that may have the potential of causing noise disturbances, such as microphone feedback or echo, and to avoid or significantly minimize such potential of noise disturbances, in one embodiment, dynamic adjustment of settings may be recommended and performed at one or more audio I/O devices 238A, 238B, 238C, 258A, 258B, 258C, 240A, 240B, 240C, 260A, 260B, 260C. Some of the aforementioned scenarios may include, but are not limited to, a user moving to another location (e.g., a few inches or several feet or even miles away) and simultaneously moving/removing one or more of the participating devices 232A, 232B, 232C, 252A, 252B, 252C to that location, a new or additional user moving into one of rooms 230, 250 or to another location altogether to add one or more new participating devices to the ongoing conference, a room that is emptier and/or much larger than another room (resulting in a greater chance of causing an echo), a door of one of the rooms 230, 250 opening, background noises (e.g., traffic, people), technical difficulties, or the like.

Communication/configuration logic 218 may facilitate the ability to dynamically communicate and stay configured with any number and type of audio I/O devices, video I/O devices, audio/video I/O devices, telephones and other conferencing tools, etc. Communication/configuration logic 218 further facilitates the ability to dynamically communicate and stay configured with various computing devices (e.g., mobile computing devices (such as various types of smartphones, tablet computers, laptop, etc.), networks (e.g., Internet, cloud-computing network, etc.), websites (such as social networking websites (e.g., Facebook®, LinkedIn®, Google+®, etc.)), etc., while ensuring compatibility with changing technologies, parameters, protocols, standards, etc.

It is contemplated that any number and type of components may be added to and/or removed from adjustment mechanism 110 to facilitate various embodiments including adding, removing, and/or enhancing certain features. For brevity, clarity, ease of understanding, and to avoid obscuring adjustment mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

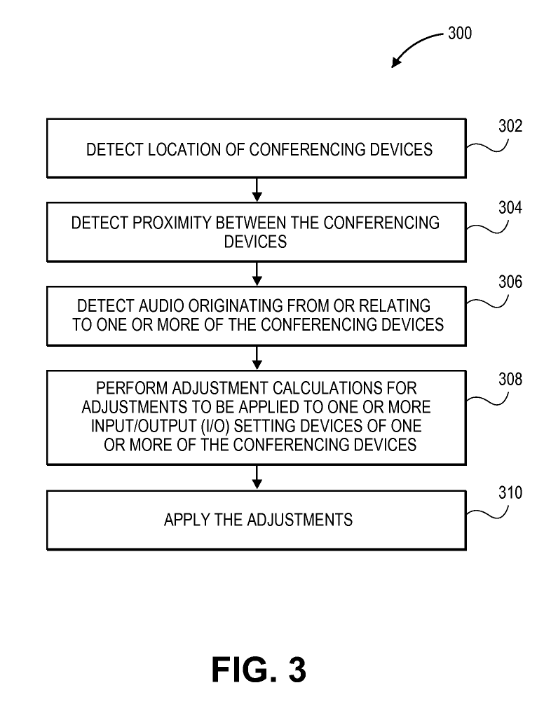

FIG. 3 illustrates a method 300 for facilitating dynamic adjustment of audio input/output setting devices at conferencing computing devices according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by adjustment mechanism 110 of FIG. 1.

Method 300 begins at block 302 with the detection of conference participating computing devices and their locations. At block 304, using the location information obtained from the process of block 302, the proximity between various participating devices is detected, such as the participating devices' proximity to each other. At block 306, in one embodiment, any form of audio (e.g., sound, noise, feedback, echo, etc.) may be detected including any audio emitting or originating from or relating to one or more of the participating computing devices. As aforementioned with respect to FIG. 2, in some embodiments, certain noise disturbances (e.g., a feedback and/or an echo, etc.) may be anticipated and/or it's level (e.g., in decibels) may be predicted upon detection of other audio, technical problems, changing scenarios (a participating device being and/or removed, etc.), or the like.

In one embodiment, at block 308, the detected and/or anticipated audio information is then used to perform adjustment calculations for dynamic adjustments to be recommended and applied (automatically, and in some cases as preferred by the user, manually) to one or more I/O setting devices (e.g., microphones, speakers, etc.) at one or more of the participating devices. At block 310, as calculated and recommended, the dynamic adjustments are applied or executed at the one or more audio setting devices. In some embodiments, the dynamic adjustments may be recommended and/or applied through user interfaces at the participating devices.

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components.

Computing system 400 includes bus 405 (or a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may including one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Some embodiments pertain to a method comprising: maintaining awareness of proximity between a plurality of computing devices participating in a conference; detecting audio disturbance relating to the plurality of computing devices; and calculating adjustments to settings of one or more audio input/output (I/O) devices coupled to one or more of the plurality of computing devices to eliminate the audio disturbance, wherein the adjustments are dynamically applied to the settings of the one or more audio I/O devices.

Embodiments or examples include any of the above methods further comprising determining a location of each of the plurality of computing devices, wherein locations of the plurality of computing devices are used to determine the proximity.

Embodiments or examples include any of the above methods further comprising detecting a sound, wherein the sound includes a normal sound or an audio disturbance, wherein the normal sounds includes a human voice and wherein the audio disturbance includes a feedback or an echo.

Embodiments or examples include any of the above methods further comprising detecting the feedback, and detecting the echo.

Embodiments or examples include any of the above methods further comprising automatically anticipating the feedback or the echo based on the detected audio disturbance, wherein automatic anticipation further includes predicting a decibel level of the feedback or the echo.

Embodiments or examples include any of the above methods wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

Embodiments or examples include any of the above methods wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

Embodiments or examples include any of the above methods wherein a computing device of the plurality of device comprises one or more of a desktop computer, a server computer, a set-top box, and a mobile computer including one or more of a smartphone, a personal digital assistant (PDA), a tablet computer, an e-reader, and a laptop computer.

Another embodiment or example includes and apparatus to perform any of the methods mentioned above.

In another embodiment or example, an apparatus comprises means for performing any of the methods mentioned above.

In yet another embodiment or example, at least one machine-readable storage medium comprising a plurality of instructions that in response to being executed on a computing device, causes the computing device to carry out a method according to any of the methods mentioned above.

In yet another embodiment or example, at least one non-transitory or tangible machine-readable storage medium comprising a plurality of instructions that in response to being executed on a computing device, causes the computing device to carry out a method according to any of the methods mentioned above.

In yet another embodiment or example, a computing device arranged to perform a method according to any of the methods mentioned above.

Some embodiments pertain to an apparatus comprising: proximity awareness logic to maintain awareness of proximity between a plurality of computing devices participating in a conference; audio detection logic to detect audio disturbance relating to the plurality of computing devices; and adjustment logic to calculate adjustments to settings of one or more audio input/output (I/O) devices coupled to one or more of the plurality of computing devices to eliminate the audio disturbance, wherein the adjustments are dynamically applied to the settings of the one or more audio I/O devices.

Embodiments or examples include any of the above apparatus further comprising locator to determine a location of each of the plurality of computing devices, wherein locations of the plurality of computing devices are used to determine the proximity.

Embodiments or examples include any of the above apparatus wherein the audio detection logic comprises a sound detector to detect a sound, wherein the sound includes a normal sound or an audio disturbance, wherein the normal sounds includes a human voice and wherein the audio disturbance includes a feedback or an echo.

Embodiments or examples include any of the above apparatus wherein the audio detection logic comprises a feedback detector to detect the feedback, and an echo detector to detect the echo.

Embodiments or examples include any of the above apparatus wherein adjustment logic is further to automatically anticipate the feedback or the echo based on the detected audio disturbance, wherein automatic anticipation further includes predicting a decibel level of the feedback or the echo.

Embodiments or examples include any of the above apparatus wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

Embodiments or examples include any of the above apparatus wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

Embodiments or examples include any of the above apparatus wherein a computing device of the plurality of device comprises one or more of a desktop computer, a server computer, a set-top box, and a mobile computer including one or more of a smartphone, a personal digital assistant (PDA), a tablet computer, an e-reader, and a laptop computer.

Some embodiments pertain to a system comprising: a computing device having a memory to store instructions, and a processing device to execute the instructions, the computing device further having a mechanism to: maintain awareness of proximity between a plurality of computing devices participating in a conference; detect audio disturbance relating to the plurality of computing devices; and calculate adjustments to settings of one or more audio input/output (I/O) devices coupled to one or more of the plurality of computing devices to eliminate the audio disturbance, wherein the adjustments are dynamically applied to the settings of the one or more audio I/O devices.

Embodiments or examples include any of the above system further comprising determining a location of each of the plurality of computing devices, wherein locations of the plurality of computing devices are used to determine the proximity.

Embodiments or examples include any of the above system further comprising detecting a sound, wherein the sound includes a normal sound or an audio disturbance, wherein the normal sounds includes a human voice and wherein the audio disturbance includes a feedback or an echo.

Embodiments or examples include any of the above system further comprising detecting the feedback, and detecting the echo.

Embodiments or examples include any of the above system further comprising automatically anticipating the feedback or the echo based on the detected audio disturbance, wherein automatic anticipation further includes predicting a decibel level of the feedback or the echo.

Embodiments or examples include any of the above system wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

Embodiments or examples include any of the above system wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

Embodiments or examples include any of the above system wherein a computing device of the plurality of device comprises one or more of a desktop computer, a server computer, a set-top box, and a mobile computer including one or more of a smartphone, a personal digital assistant (PDA), a tablet computer, an e-reader, and a laptop computer.

Embodiments or examples include any of the above system further comprising detecting or automatically anticipating the feedback or the echo based on the detected audio disturbance, wherein automatic anticipation further includes predicting a decibel level of the feedback or the echo, wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

Embodiments or examples include any of the above system wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet, wherein a computing device of the plurality of device comprises one or more of a desktop computer, a server computer, a set-top box, and a mobile computer including one or more of a smartphone, a personal digital assistant (PDA), a tablet computer, an e-reader, and a laptop computer.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. An apparatus to manage audio disturbances in a conference, comprising:
proximity awareness logic to maintain awareness of proximity between a plurality of computing devices participating in a conference;
audio detection logic to detect audio disturbance relating to the plurality of computing devices; and
adjustment logic to calculate adjustments to settings of one or more audio input/output (I/O) devices coupled to one or more of the plurality of computing devices to eliminate the audio disturbance, wherein the adjustments are dynamically applied to the settings of the one or more audio I/O devices.

2. The apparatus of claim 1, further comprising device locator to determine a location of each of the plurality of computing devices, wherein locations of the plurality of computing devices are used to determine the proximity.

3. The apparatus of claim 1, wherein the audio detection logic comprises a sound detector to detect a sound, wherein the sound comprises a normal sound or an audio disturbance, wherein the normal sounds comprises a human voice and wherein the audio disturbance comprises a feedback or an echo.

4. The apparatus of claim 3, wherein the audio detection logic further comprises a feedback detector to detect the feedback, and an echo detector to detect the echo.

5. The apparatus of claim 4, wherein adjustment logic is further to automatically anticipate the feedback or the echo based on the detected audio disturbance, wherein automatic anticipation further comprises predicting a decibel level of the feedback or the echo.

6. The apparatus of claim 1, wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

7. The apparatus of claim 6, wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

8. The apparatus of claim 1, wherein a computing device of the plurality of device comprises one or more of a desktop computer, a server computer, a set-top box, and a mobile computer comprising one or more of a smartphone, a personal digital assistant (PDA), a tablet computer, an e-reader, and a laptop computer.

9. A method for managing audio disturbances in conferencing, comprising:
maintaining awareness of proximity between a plurality of computing devices participating in a conference;
detecting audio disturbance relating to the plurality of computing devices; and
calculating adjustments to settings of one or more audio input/output (I/O) devices coupled to one or more of the plurality of computing devices to eliminate the audio disturbance, wherein the adjustments are dynamically applied to the settings of the one or more audio I/O devices.

10. The method of claim 9, further comprising determining a location of each of the plurality of computing devices, wherein locations of the plurality of computing devices are used to determine the proximity.

11. The method of claim 9, further comprising detecting a sound, wherein the sound comprises a normal sound or an audio disturbance, wherein the normal sounds comprises a human voice and wherein the audio disturbance comprises a feedback or an echo.

12. The method of claim 9, further comprising detecting the feedback, and detecting the echo.

13. The method of claim 9, further comprising automatically anticipating the feedback or the echo based on the detected audio disturbance, wherein automatic anticipation further comprises predicting a decibel level of the feedback or the echo.

14. The method of claim 9, wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

15. The method of claim 14, wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet.

16. The method of claim 9, wherein a computing device of the plurality of device comprises one or more of a desktop computer, a server computer, a set-top box, and a mobile computer comprising one or more of a smartphone, a personal digital assistant (PDA), a tablet computer, an e-reader, and a laptop computer.

17. A system to manage audio disturbances in a conference, comprising:
a computing device having a memory to store instructions, and a processing device to execute the instructions, the computing device further having a mechanism to:
maintain awareness of proximity between a plurality of computing devices participating in a conference;
detect audio disturbance relating to the plurality of computing devices; and
calculate adjustments to settings of one or more audio input/output (I/O) devices coupled to one or more of the plurality of computing devices to eliminate the audio disturbance, wherein the adjustments are dynamically applied to the settings of the one or more audio I/O devices.

18. The system of claim 17, further comprising determining a location of each of the plurality of computing devices, wherein locations of the plurality of computing devices are used to determine the proximity.

19. The system of claim 17, further comprising detecting a sound, wherein the sound comprises a normal sound or an audio disturbance, wherein the normal sounds comprises a human voice and wherein the audio disturbance comprises a feedback or an echo.

20. The system of claim 19, further comprising detecting or automatically anticipating the feedback or the echo based on the detected audio disturbance, wherein automatic anticipation further comprises predicting a decibel level of the feedback or the echo, wherein the dynamic application of the adjustments to the settings of the one or more audio I/O devices is performed via user interfaces provided by software applications at the plurality of computing devices, and wherein the adjustments are recommended to the plurality of computing devices by execution logic and via the user interfaces.

21. The system of claim 20, wherein a software application comprises one or more of a conferencing software application, a conferencing website, and a social networking website, wherein the plurality of computing devices are coupled to each other over a network, wherein the network comprises one or more of a cloud-based network, a Local Area Network (LAN), a Wide Area Network (WAN), a Metropolitan Area Network (MAN), a Personal Area Network (PAN), an intranet, an extranet, or the Internet, wherein a computing device of the plurality of device comprises one or more of a desktop computer, a server computer, a set-top box, and a mobile computer comprising one or more of a smartphone, a personal digital assistant (PDA), a tablet computer, an e-reader, and a laptop computer.

22. (canceled)

23. (canceled)

24. (canceled)

25. (canceled)

26. At least one machine-readable medium comprising a plurality of instructions that in response to being executed on a computing device, causes the computing device to carry out one or more operations comprising:
maintaining awareness of proximity between a plurality of computing devices participating in a conference;
detecting audio disturbance relating to the plurality of computing devices; and
calculating adjustments to settings of one or more audio input/output (I/O) devices coupled to one or more of the plurality of computing devices to eliminate the audio disturbance, wherein the adjustments are dynamically applied to the settings of the one or more audio I/O devices.

27. The machine-readable medium of claim 26, wherein the one or more operations comprise determining a location of each of the plurality of computing devices, wherein locations of the plurality of computing devices are used to determine the proximity.

28. The machine-readable medium of claim 26, wherein the one or more operations comprise detecting a sound, wherein the sound comprises a normal sound or an audio disturbance, wherein the normal sounds comprises a human voice and wherein the audio disturbance comprises a feedback or an echo.
